(19) United States
(12) Patent Application Publication
(10) Pub. No.: US 2004/0138944 A1
(43) Pub. Date: Jul. 15, 2004

(54) Program performance management system

(76) Inventors: Cindy Whitacre, Jacksonville, FL (US); Myra Royall, Jacksonville, FL (US); Tom D. Olsen, Salt Lake City, UT (US); Tina Schulze, Saint Charles, MO (US); Robert White, Jacksonville, FL (US); Nancy Newman, Jacksonville, FL (US)

Correspondence Address: FROST BROWN TODD LLC, 2200 PNC Center, 201 E. Fifth Street, Cincinnati, OH, 45202-4182, US

(21) Appl. No.: 10/624,283

(22) Filed: Jul. 22, 2003

Related U.S. Application Data
(60) Provisional application No. 60/397,651, filed on Jul. 22, 2002.

(51) Int. Cl. G06F 17/60

(52) U.S. Cl. 705/11

(57) ABSTRACT

A Program Performance Management (PPM) system enforces consistency in feedback and coaching to employees across the organization lower attrition through improved morale and job satisfaction. Employees are empowered because they can review their status and thus feel that they have more control over their ratings. Consistency in performance data is maintained across an enterprise. Management insights are gained by comparisons made across projects, programs, and Business Units on standardized measures, thereby enabling accountability at all levels. Integration of quantitative information and qualitative assessments of Customer Management System (CMS) agents performance is summarized and plotted in an intuitive fashion, with feedback acknowledgements and reviews tracked for management. Team leaders have a scorecard interface to efficiently supervise their team members. Agents have access to a dashboard that provides up to date and intuitive indications of their performance and that of their fellow team members.

### CROSS REFERENCE TO RELATED APPLICATIONS

The present application hereby claims the benefit of the provisional patent application entitled “PROGRAM PERFORMANCE MANAGEMENT SYSTEM” to Shawn R. Anderson, Serial No. 60/397,651, filed on 22 Jul. 2002.

### FIELD OF THE INVENTION

The present invention relates, in general, to devices and methods that correlate and display employee performance evaluation factors, both objective and subjective, and track their updates, dissemination, and review, and more particularly to computer-based devices and methods particularly suited to evaluating customer service agents.

### BACKGROUND OF THE INVENTION

Accurate and timely employee evaluations are important for motivating good employees and taking corrective action with not-so-good employees. While this is generally true for all industries and services, customer service providers have a particular need for a comprehensive approach to agent evaluation. Each contact with an agent may positively or adversely impact a customer's perception of a business.

While customer care management is a challenging service in and of itself, recent trends are for outsourcing this function in order to leverage customer care management technology, expertise, and economies of scale. However, such a decision is not made without reservations. For instance, a business may be concerned that a Customer Management Service (CMS) provider would tend to have outsourced agents that are not as motivated to perform their duties well as the business's own employees. These businesses in particular may not deem the CMS provider to have comprehensive and transparent program performance management capabilities to provide this confidence.

Even if the CMS provider may demonstrate an agent evaluation process, a business may yet be concerned about how do these processes effectively manage performance to achieve the specific business goals of the business, rather than a generic, non-tailored process. Furthermore, even if tracking performance factors of value to the business, does the CMS provider ensure that performance feedback and coaching is truly delivered to agents in a timely manner to ensure its efficacy. Finally, even if the evaluation process is appropriate and timely for the business, another concern is that the performance data is unduly subjective and haphazardly reported.

Consequently, a significant need exists for an approach to performance management that is suitable for motivating agents who provide customer care, that is disseminated and reviewed in a timely fashion, and that is rigorously tracked and subject to audit to enhance confidence in its efficacy and accuracy.

### BRIEF SUMMARY OF THE INVENTION

The invention overcomes the above-noted and other deficiencies of the prior art by providing a performance management system and method that comprehensively addresses qualitative and quantitative measurands of performance for each agent and group of agents, intuitively displays this information in a meaningful fashion to various levels of supervision, including each agent, and tracks the updates, dissemination, and review of performance feedback through each tier of supervision. Sources of information are sourced and tracked in such a way that accuracy and objectivity are enhanced, increasing confidence. Thereby, agent performance is enhanced through timely and appropriate feedback. Efficacy of overall performance management is made transparent to each level of an organization, including a customer for these services.

In one aspect of the invention, a plurality of quantitative and qualitative measures are selected as being aligned with appropriate business goals. These measures are collected, merged and analyzed in an objective manner to represent the various performance attributes of an agent. Results are then displayed in an intuitive graphical user interface that readily conveys these attributes, both individually and as compared to an overall group. Thereby, each agent has a current snapshot as to their standing in the eyes of their employer, with its implications for retention and possibly pay for performance, to thus motivate improved performance. Frequent reporting ensures that you will always know how the CMS provider and its individual agents are performing. Regular feedback to each agent helps ensure continuous agent development.

In another aspect of the invention, a plurality of quantitative and qualitative measures are monitored and collected for each agent, wherein these qualitative measures include supervisory evaluations. Timeliness of supervisory evaluations is tracked, as well as agent review of feedback based on the quantitative and qualitative measures.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a block diagram of a Program Performance Management (PPM) System incorporated into a Customer Management System (CMS) network.

FIG. 2 is a sequence of operations performed by the PPM System of FIG. 1.

FIG. 3 is a depiction of an employee scorecard graphical user interface (GUI) of the PPM system of FIG. 1 useful for a team leader in performing manual update operations and root cause analysis.

FIG. 4 is a depiction of an agent dashboard graphical GUI generated by the PPM system of FIG. 1 indicating a comparison of an agent's performance to standards and to peers.

FIG. 5 is a depiction of a queued acknowledgement form GUI generated by the PPM system of FIG. 1.

FIG. 6 is a depiction of recent acknowledgements report generated by the PPM system of FIG. 1.

FIG. 7 is a depiction of acknowledgement detail report generated by the PPM system of FIG. 1.

FIG. 8 is a depiction of an employee performance feedback sheet generated by the PPM system of FIG. 1.

FIG. 9 is a depiction of a team leader acknowledgement queue form generated by the PPM system of FIG. 1.

FIG. 10 is a depiction of scorecard acknowledgement event detail report generated by the PPM system of FIG. 1.

FIG. 11 is a depiction of an employee review rankings report generated by the PPM system of FIG. 1.

FIG. 12 is a depiction of a measure daily exclusion screen generated by the PPM system of FIG. 1.

FIG. 13 is a depiction of a performance trending report generated by the PPM system of FIG. 1.

FIG. 14 is a depiction of an account report generated by the PPM system of FIG. 1.

FIG. 15 is a depiction of an acknowledgement detail report generated by the PPM system of FIG. 1.

FIG. 16 is a depiction of an acknowledgement summary report generated by the PPM system of FIG. 1.

FIG. 17 is a depiction of summary review form generated by the PPM system of FIG. 1.

### DETAILED DESCRIPTION OF THE INVENTION

Performance Management is the effective deployment of the right people, processes and technology to develop our employees for optimal results. Employees who achieve outstanding business results, will earn more money, the performance management process ensures a consistent, standardized method in which we are measuring our Agents' performance and providing specific improvement opportunity feedback. The benefits as a result of utilizing the performance management process are consistency in feedback and coaching to employees across the organization; Employees will be able to review their status and consequently feel they have more control over their ratings; empowered employees, resulting in improved morale and job satisfaction; improved performance; and reduced attrition.

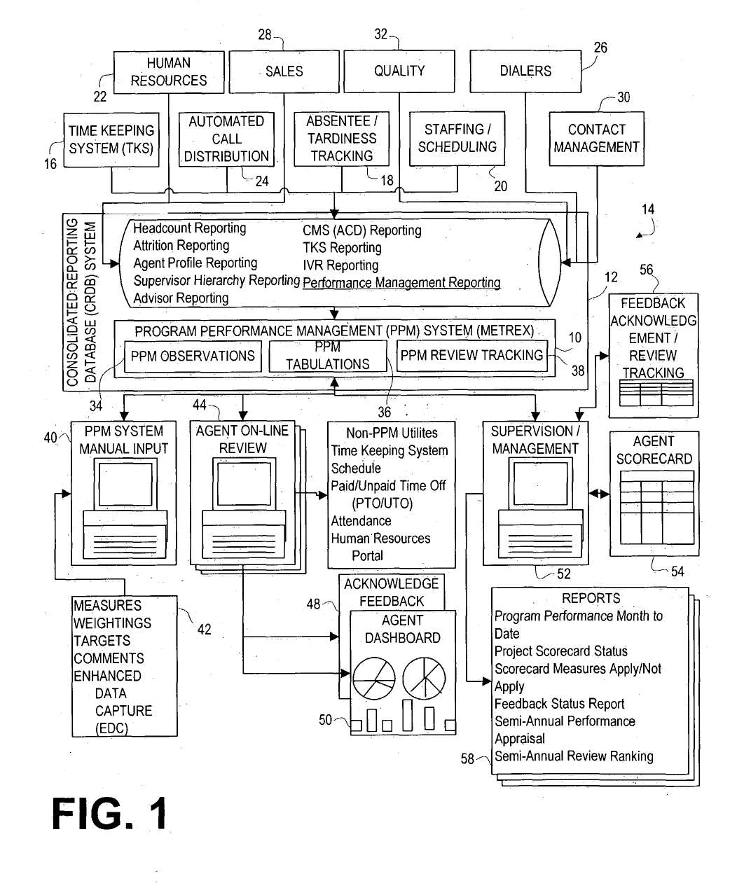

Turning to the Drawings, wherein like numerals denote similar components throughout the several views, in FIG. 1, a program performance management (PPM) system 10 (aka “Metrex”) is functionally depicted as advantageously leveraging a broad range of quantitative data sources available to a Consolidated Reporting Database (CRDB) 12 as part of a customer management system (CMS) network 14. In particular, The CRDB system 12 is a reporting tool utilized to access multiple project reports and to maintain accurate team and employee listings. The accurate listings are important when accessing Agent-level PPM performance data. The existing CRDB system 12 provides benefits include creation of reports by pulling from other sources, therefore eliminating the need for manual input of data; reduction in the time needed to pull reports and to produce reports by pulling together data from existing systems into one place; maintenance of accurate team and agent identification (IDs); and allowance for custom reporting.

The CRDB system 12 interfaces with a number of components, processes or systems from which information may be received that has bearing on agent (i.e., employee), team leader (i.e., supervisor), project, and management performance. First, in an exemplary group of inputs, a Time Keeping System (TKS) 16 used for payroll functions. In addition to being a source of absence and tardy data on each agent, the TKS system 16 may detail time spent coaching, in meeting, in training, or administrative tasks. There may other Absentee/Tardiness Tracking components 18 that augment what is available from a payroll-focused capability. For example, “clocking in” may be performed as a time and place removed from the actual worksite with more detailed information being available based on an agent's interaction with a log-in function at their station.

A team leader maintains a staffing/scheduling process 20, such as DIGITAL SOLUTIONS by ______, manage the schedule adherence of team members and to document any feedback to Agents, thereby enhancing the team statistics and managing the team efficiently. For absences, an agent calls an Interactive Voice Recognition (IVR) interface to report that he will be absent. If the Agent is absent for consecutive days, the Agent's file in staffing scheduling process 20 is maintained to adjust the number of occurrences, including adjustments for agent earnbacks and exceptions for approved leave of absence, such as under the Family and Medical Leave Act (FMLA). Other types of absence data maintained includes No Call, No Show (NCNS) for an entire shift as well as showing up late (i.e., tardy).

The CRDB system 12 may advantageously interface to a Human Resources (HR) system 22 that provides guidelines associated with leaves of absence, appropriate feedback procedures, and other attendance policies. The HR system 22 also provides updates on attrition, hiring, transfers, etc.

The amount of time by each agent spent handling inbound calls is logged by an Automated Call Distribution (ACD) system 24. Similarly, the amount of time by each agent spent handling outbound calls is logged by Dialers 26. Sales made in response to an ACD call are tracked by a Sales system 28. Similarly, a wider range of agent contacts may be managed, such as customer contacts initiated by email or a website form, on a Contact Management System 30. Agents are to disposition all customer contacts in an Information Technology (IT) outlet so that a comparison of all calls handled by ACD shows that all were dispositioned.

In addition to the range of quantitative information that represents agent performance, qualitative information is gathered about the agent, depicted as a quality system 32. One source of assessments of agent performance may be observations input by a team leader. Another may be by a quality assurance (QA) entity.

These sources of information allow for the CRDB system 12 to maintain a range of reports: headcount reporting, attrition reporting, agent profile reporting, supervisory hierarchy reporting, advisor reporting, CMS ACD reporting, TKS reporting, IVR reporting, and Performance Management Reporting. The latter is produced by the PPM system 10 in conjunction with unique PPM observations 34, PPM tabulations 36, and PPM review tracking 38.

The data and reporting capabilities of the CRDB system 12 and PPM system 10 are interactively available to great advantage by administers who may customize the PPM system via a PPM system manual input system 40 with manual inputs 42, such as selecting what measures are to be assessed, weighting to be applied to the measures, target ranges for grading the weighted measures, and enabling inputs of qualitative assessments, such as comments and enhanced data capture.

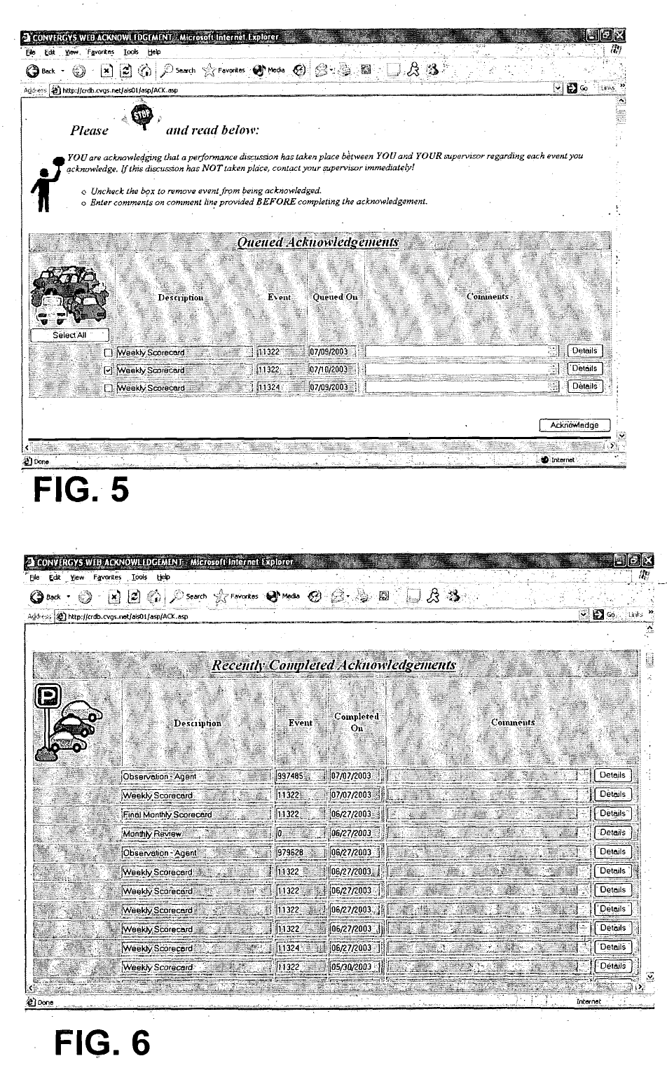

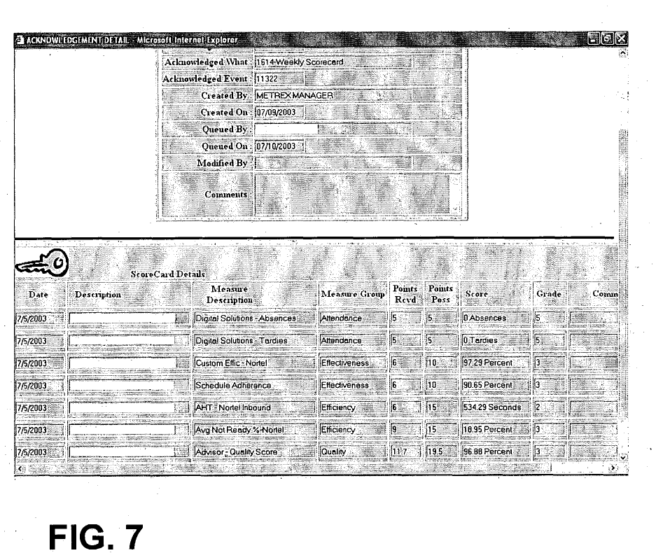

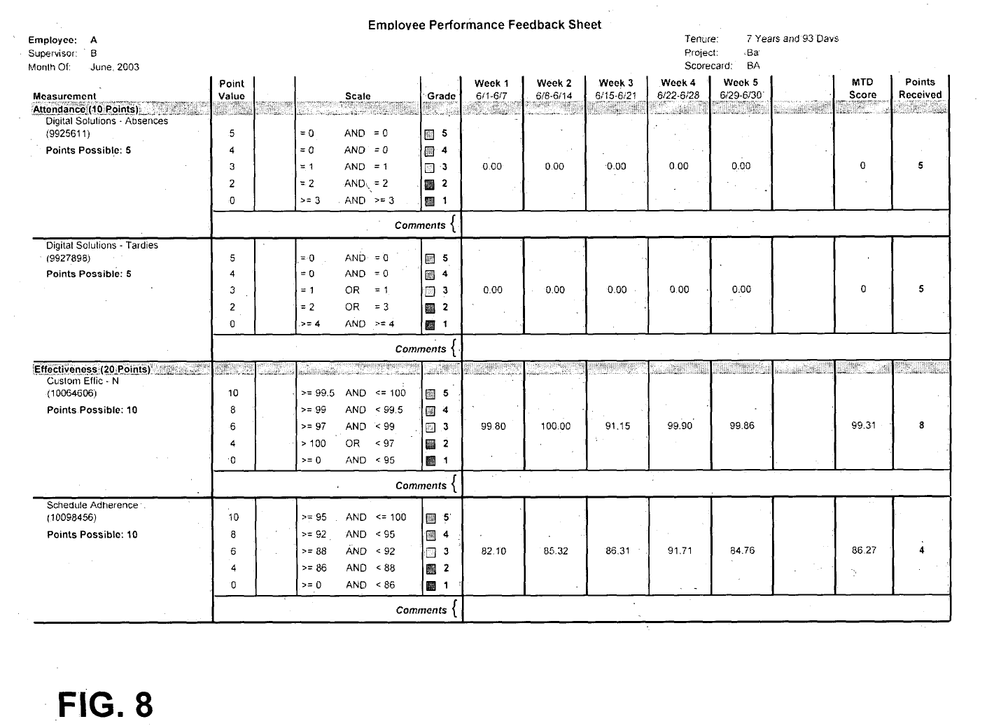

In addition, agents may access via an agent on-line review system 44 various non-PPM utilities 46, such as time keeping system information, schedule, paid time off (PTO), unpaid time off (PTO), attendance, and a Human Resources portal to assignment and policy guidance. On a frequent basis, the agent may access or be automatically provided acknowledgement feedback forms 48 as follow-up to supervisory feedback sessions (See FIGS. 5, 6, 7.) as well as an performance feedback sheet that shows trends in performance. (See FIG. 8.) In addition, the agent may make frequent reference to an agent dashboard 50 that comprehensively and intuitively depicts the agent's performance as compared to targets and as compared to his peers on the team.

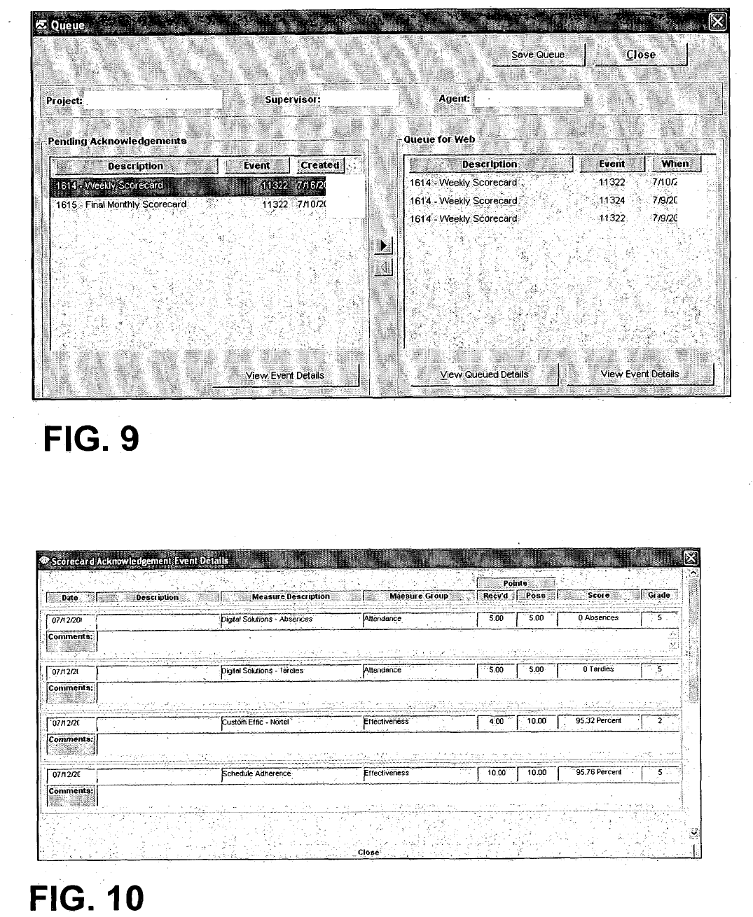

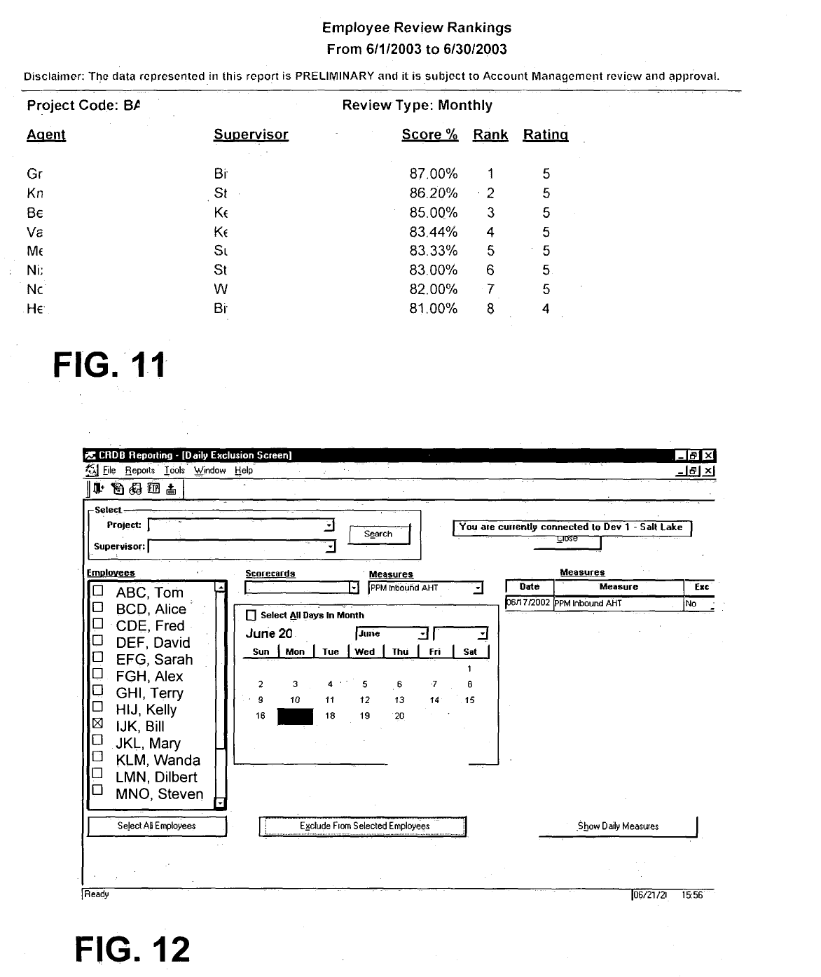

A team leader interacts with the PPM system 10 through a supervision/management computer 52 to update and monitor agent performance on an agent scorecard 54. When performance indications from the scorecard warrant corrective action, the team leader performs root cause analysis, initiates a corrective action plan with the agent, and inputs feedback acknowledgment tracking forms 56 into the PPM system 10. (See FIGS. 9, 10.) The team leader or his management may also access PPM reports 58, such as program performance month to date, project scorecard status, scorecard measures applied/not applied, feedback status report, semi-annual performance appraisal, and semi-annual review ranking. (See FIG. 11.)

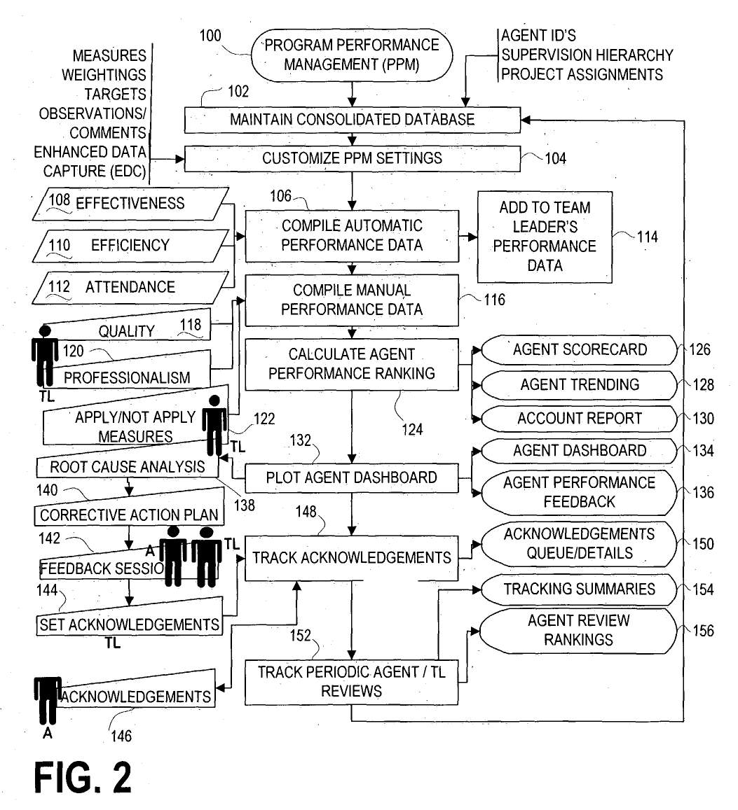

In FIG. 2, a sequence of operations, or PPM process 100, is implemented by the PPM system 10 of FIG. 1 to effectively supervise and manage employees. It should be appreciated that the process 100 is depicted as a sequential series of steps between a team leader and an agent for clarity; however, the PPM process 100 is iteratively performed across an enterprise with certain steps prompted for frequent updates.

In block 102, maintenance of a consolidated reporting database is performed so that organizational and performance related information are available, for example maintaining employee or agent identifiers (ID's), a supervision hierarchy, and project assignments, which may be more than one per employee. Typically, a team leader periodically reviews a listing of his direct reports maintained in a time keeping system to make sure that these are accurate, taking appropriate steps to initiate a change if warranted.

In block 104, an administrator of the PPM system may customize what measures are used, the weightings given for these measures for a combined score, target ranges for evaluating the degree of success for each measure, implementations that designate how, when and by whom observations/comments are incorporated into the combined score, and other enhanced data capture (ENC) features.

With the PPM system prepared, automatic performance data is compiled (block 106) based on Effectiveness data 108, Efficiency data 110, and Attendance data 112. These measures are rolled up as well into a similar performance tracking record for the team leader's performance data (block 114). In addition to quantitative measures, manual (qualitative) performance data is compiled (block 116) from Quality data 118 and Professionalism data 120, both typically input by the team leader and/or other evaluators such as QA. In the illustrative version, a scorecard has five categories, which total 100 points. At a high level, Quality, Effectiveness and Efficiency categories may be broken out in any value, but the categories must add up to 100%. In the illustrative version, an 80% share is divided among three categories: Quality (based on overall quality score), Effectiveness (based on Average Handle Time (AHT) and After Call Work (ACW)), and Efficiency (based on schedule adherence). Ten percent is Attendance (based on the tardiness and absences). The final ten-percent is Professionalism (based on teamwork and integrity). However, it should be appreciated that these specific characteristics and percentages are exemplary only and that other combinations may be selected for a specific application consistent with aspects of the invention.

In block 122, Managers have the ability to apply or not apply measures. This provides management the flexibility to compensate for elements outside an employee's control and correct input errors for manual measures. A “Scorecard Measures Apply/Not Apply report” is available to ensure that this function is used properly. There are a few instances when scorecard measures may need to be excluded from the scorecard. Some examples are shown below that illustrate when a measure may need to be “not applied”. (See FIG. 12.) When an employee works in a temporary assignment that will not extend past 30 days. It may be appropriate, depending on the circumstances, to not apply the second scorecard's Quality and Efficiency measures. Note: The system automatically generates another scorecard, when an employee works on another team or project that has an existing scorecard. If a manager inputs a manual measure twice for the same month, one of the duplicate measures may be marked as “not applied”. If something outside of employees' control has impacted a specific measure across the majority of the project, the measure may need to be not applied for the entire project.

There are several impacts that occur when a measure is not applied. A measure that is “Not Applied” will not populate on the scorecard. The scorecard automatically changes the weightings of the scorecard, and only applied measures will be totaled. Not applied measures will exclude the data for that measure on higher level scorecards (i.e., Team Leader, Operations Manager, etc.) and all types of project or team level reporting. Managers will use the Metrex system to not apply or apply measures. The Employee Performance and Attendance folder may be selected and choose the “Employee Scorecard” for Agents and the “Management Scorecard” for Team Leaders and above.

In block 124, agent measures are calculated to determine how the agent compares against the standards and against their peers for the current and historical rating periods.

Quality Score.

A quality score is derived by pulling the overall quality score from either e-Talk (Advisor), Metrex Observations or EDC (Enhanced Data Capture). The final score is the average of all quality evaluations for an Agent within the month. An exemplary formula is:

(QA OVERALL QUALITY SCORE+TEAM LEADER OVERALL QUALITY SCORE)/(QA OVERALL # OF MONITORINGS+TL OVERALL # OF MONITORINGS)

The above-described formula pulls automatically from either Advisor or Metrex Observation. If a system other than the above mentioned is utilized, manual entry may be necessary. In the illustrative embodiment, each measure has a set of five ranges that are possible to achieve, corresponding to a grade of 5, 4, 3, 2, 1, and having the following names respectively: Key Contributor (“KC”), Quality Plus Contributor (“QPC”), Quality Contributor (“QC”), Contribution Below Expectations (“CBE”), and Contribution Needs Immediate Improvement (“CNII”). Suggested Targets are for KC: 100%-97%; QPC: 96%-95%; QC: 94%-87%; CBE: 86% 82%; NII: 81%-0.

Efficiency Category

Inbound Average Handle Time (AHT) is the length of time it takes for an Agent to handle a call. There are various factors that affect inbound AHT. The formula below outlines the most inclusive factors for providing the complete calculation for inbound AHT. An exemplary formula is:

(I_ACDTIME+DA_ACDTIME+I_ACDAUX_OUTTIME+I_ACDOTHERTIME+I_ACWTIME+I_DA_ACWTIME+TI_AUXTIME)/(ACDCALLS+DA_ACDCALLS).

With regard to the above-described formula, the Inbound AHT calculation captures all three of ACD time, which includes the time an Agent spends calling out during a call; Hold time, which includes all of the activities an Agent performs while a call is on hold; and After Call Work time. The latter includes potential IB or OB non-ACD calls made to complete the customer's call, non-ACD calls made or received while in the ACW mode, and time in ACW while the Agent is not actively working an ACD call.

AUX time includes all of the AUX time captured no matter what the Agent is doing (i.e., including making or receiving non-ACD calls). The value of capturing all of the AUX time is the accountability that it creates for the Agents. It drives proper and accurate phone usage by Agents.

Outbound Average Handle Time (AHT) is the length of time it takes for an Agent to handle a call. There are various factors that affect outbound AHT. The formula below outlines the most inclusive factors for providing the complete calculation for outbound AHT. An exemplary formula is:

(ACW TIME+AUX OUT TIME)/(AUX OUT CALLS+ACW OUT CALLS)

With regard to the above-described formula, the Outbound AHT captures the total time an Agent spends on a call while logged into the switch but not handling regular Inbound ACD calls. The ACW Time contains all of the time an Agent is in ACW, while logged into the phone, placing a call, and the actual Talk Time of that call. The AUX Out Time contains all of the time an Agent is in AUX placing calls and talking on calls. ACW and AUX are the only modes that Agents can place themselves in and still be able to place outbound calls.

The After Call Work (ACW) percentage is the percent of time an Agent spends in ACW following an ACD call. It measures the percentage of actual online time an Agent spends in ACW without counting AUX time. This provides a clean view of an Agent's use of ACW to handle actual calls and removes the various activities that may be performed, while an Agent is in AUX. An exemplary formula is:

(I_ACW_TIME+DA_ACW_TIME)*100/(TI_STAFF_TIME−TI_AUX_TIME−AUX_IN_TIME−AUX_OUT_TIME)

With regard to the above-described formula, the ACW % measure captures the Agent's total ACW time and calculates the percentage by dividing the total ACW time by the Agent's Staff time removing the Total AUX time to create a pure online time then multiplying by 100 to create the percentage figure. Suggested Targets are KC: 0-10%; QPC: 11%-15%; QC: 16%-20%; CBE: 21%-25%; CNII: 26%-above.

Average After Call Work (ACW) is an actual average of the time an Agent spends in ACW following an ACD call. The average ACW measure provides the average number of seconds in ACW and is an accurate view of the actual time an Agent spends in ACW. For projects that bill for ACW, this measure provides a quick view of the potential ACW that may be included on the bill. An exemplary formula is:

(I_ACW_TIME+DA_ACW_TIME)/(ACD_CALLS+DA_ACD_CALLS)

With regard to the above-described formula, Average ACW captures the Agent's total ACW time and calculates the average by dividing the ACW time by the total ACD calls the Agent receives. This provides the Agent's average, which can be used for projected billing when applicable. AUX time is the time an Agent spends in AUX work logged into the Split. True AUX time, which is the time an Agent spends doing various activities, provides an accurate view of the time Agents spend performing activities other than actual calls. An exemplary formula is:

(TI_AUX_TIME−AUX_IN_TIME−AUX_OUT_TIME)*100/TI_STAFF_TIME

With regard to the above-described formula, I_AUX time includes I_AUX_In time and I_AUX_Out time. AUX_In time and AUX_Out time are actually time spent by an Agent placing or receiving non-ACD calls, so to capture true AUX these two components must be removed from the total AUX time. AUX time captures all of the AUX reason codes to prevent Agents from selecting codes not reported. Suggested Targets are KC: 0-4%; QPC: 5%-7%; QC: 8%-11%; CBE: 12%-15%; CNII: 16%-above.

Average Talk Time (ATT) measures the actual time spent by Agents talking to customers on ACD calls. This provides a clear view of the time Agents spend talking on calls and can be used to ensure that Agents are controlling the calls. An exemplary formula is:

(ACD_TIME+DA_ACD_TIME)/(ACD_CALLS+DA_ACD_CALLS)

With regard to the above-described formula, ATT captures the Agent's Total Talk time as measured in CMS (Call Management System) and divides the result by the total number of ACD calls the Agent receives. It pulls the data directly from CMS without any components being added or removed. This makes it a pure measure of the Agent's actual time with the customer.

Information Technology (IT) Sales Conversion is the percentage of sales in IT to ACD calls received by the Agent. This measure may contain Interlata, Intralata, or combined total sales. The sales type names contained in IT must be determined when a specific sales type conversion is desired such as Intralata conversion only. For example, the data label for the various sales types may be referred to as APIC rather than Intralata, etc. An exemplary formula is:

(Number of Sales)*100/(ACD Calls) or (Number of Sales)*100/(IT Calls)

With regard to the above-described formula, IT Sales Conversion captures all sales types in IT for the project and then divides that by the total ACD Calls In or IT Calls, whichever is applicable, then calculates the percentage. A specific sales conversion can be calculated using the same calculation by selecting the appropriate sales type when setting up the measure in the Agent's scorecard.

The total calls dispositioned in IT vs. CMS (Call Management System) provides a measure to confirm whether an Agent is or is not adhering to the call dispositioning step in the Agent's call handling procedures. The goal should be around 100% to ensure that all CMS calls are being properly dispositioned in IT. An exemplary formula is:

IT CALLS*100/(ACD CALLS)

With regard to the above-described formula, the total number of calls dispositioned in IT divided by the total number of CMS calls received by an Agent then multiplied by 100.

Effectiveness Category

Agent Productivity is often referred to in many project as “Adjusted Agent Yield”. This measure is intended to measure the actual online productivity of an Agent when handling calls. It is not an overall Billing Yield of an Agent. Therefore, productive time in TKS is the only time used in this calculation. An exemplary formula is:

(CMS STAFF TIME+TKS PRODUCTIVE TIME)*100/(TOTAL TKS TIME)

With regard to the above-described formula, Agent Productivity captures an Agent's total Staff time from CMS and adds that to the Agent's actual customer handling productive time in TKS, which includes mail+e-mail+data entry and divides that total by the “clock_in seconds” or total TKS, then multiplies by 100 to provide a percentage format. Suggested Targets are KC: 100%-93%; QPC: 92% 90%; QC: 89%-85%; CBE: 84%-80%; CNII: 79%-below.

Billing Yield is used to determine the actual billable work of an Agent by capturing all billable time for an Agent including team meetings, training, offline non-customer handling time, etc. This measure is not intended to provide an Agent Yield, which is captured in the Agent Productivity measure. An exemplary formula is:

(TI_STAFF TIME+(TKS_BILLABLE−TKS_ONLINE)/(TKS_PAID)

With regard to the above-described formula, Billing Yield is calculated by taking an Agent's Total Staff time from CMS and adds this to the Agent's total billable TKS time then removes the online time from TKS to avoid double counting of online time. This total is then divided by the Agent's total TKS. Suggested Targets are KC: 100%-96%; QPC: 95%-93%; QC: 92%-88%; CBE: 87%-83%; CNII: 82% below.

Schedule Adherence reflects an Agent's actual adherence to their schedules utilized by Work Force Management. It is important to maintain accurate schedules in WFM and to notify the Command Center immediately of changes, as this measure will be negatively impacted by any change. An exemplary formula is:

(Open In+Other In)*100(Open In+Open Out+Other In+Other Out)

Note: In other words, all of the time in adherence is divided by total scheduled time. With regard to the above-described formula, Schedule Adherence is calculated using the following data from IEX, total minutes in adherence (i.e., total number of minutes the scheduled activity matches the actual activity) and compares them to the total minutes scheduled, then multiplies the result by 1100. Suggested Targets are KC: 100%-95%; QPC: 94%-93%; QC: 92%-90%; CBE: 89%-87%; CNII: 86%-below.

Staffed to Hours Paid (HP) provides an overall view of the online Agent's daily time spent logged into CMS compared to the Agent's total day in TKS to determine whether or not the Agent is logging into the phones for the appropriate portion of the day. It is not intended to replace Schedule Adherence, but it provides a payroll view of an Agent's activities similar to Agent Productivity. An exemplary formula is:

(TOTAL STAFFED TIME)*100/(TOTAL_TK_DAY_SECONDS)

With regard to the above-described formula, Staffed to HP captures the Agent's Total Staff time in CMS divided by the Agent's total TKS for the day multiplied by 100. Suggested Targets are KC: 100%-90%; QPC: 89%-87%; QC: 86%-82%; QBE: 81%-77%; and CNII: 76%-below.

Attendance is a direct feed from the Digital Solutions system (i.e., Attendance IVR). The feed captures occurrences, which are applied to the Agent's scorecard. The occurrences will only be correct when Team Leaders maintenance the Digital Solutions web site. Attendance is a mandatory measure and is composed of Absences and Tardies. Formula for Attendance is based on total number of tardies and absences in a calendar month. Tardies and Absences are applied directly to the automated scorecard from Digital Solutions. If Team Leaders do not maintenance Digital Solutions on a daily basis for their Agents, the Agents scorecard occurrence count will be inaccurate.

The professionalism category assists Team Leaders in measuring Agents' performance relative to core values. There are 5 skills (i.e., Unparalleled Client Satisfaction, Teamwork, Respect for the Individual, Diversity, and Integrity), which Team Leaders manually enter into the system periodically (e.g., monthly). An example of a formula for professionalism is: Unparalleled Client Satisfaction (2 Pts)+Teamwork (2 Pts)+Respect For The Individual (2 Pts)+Diversity (2 Pts)+Integrity (2 Pts) 10 Total Points Possible. These measures compose 10% of an Agent's scorecard.

Team Leader Measures

All Agent measures in the Quality, Effectiveness, and Efficiency categories roll up to the Team Leader's scorecard. In addition, the Team leader is evaluated for Attendance and Professionalism. For Attendance, a lost hours are tracked, with the target begin a low percentage if Team Leaders are using their scheduling system effectively (e.g., DIGITAL SOLUTIONS). Formula

(IEX SCHEDULED TIME−TKS TOTAL TIME WORKED)/(IEX TOTAL TIME SCHEDULED)

With regard to the above-described formula, IEX Scheduled time is the amount of time an Agent is scheduled to work. To alter the scheduled time, Team Leaders (TL) make adjustments to Digital Solutions. The adjustments are picked up by the Command Center and applied to their IEX Schedule. The actual TKS worked hours are subtracted out of the scheduled time to create the numerator. If a TL has maintained an Agent's schedule properly in Digital Solutions, the Lost Hours % should be a low number.

Professionalism Category

The professionalism category has been developed to assist Operations Managers in measuring Team Leader's performance relative to Convergys' core values. There are 5 skills (i.e., Unparalleled Client Satisfaction, Teamwork, Respect for the Individual, Diversity, and Integrity), which Operations Managers enter into the system, manually. An exemplary formula is:

Unparalleled Client Satisfaction (2 pts)+Teamwork (2 pts)+Respect for the Individual (2 pts)+Diversity (2 pts)+Integrity (2 pts)=10 Total Points Possible

With regard to the above-described formula, Operations Managers input the manual professionalism measures monthly. These measures compose 10% of a Team Leader's scorecard.

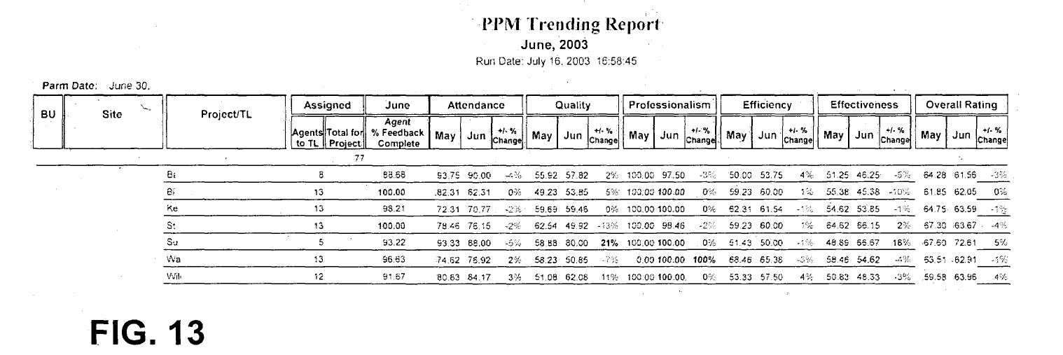

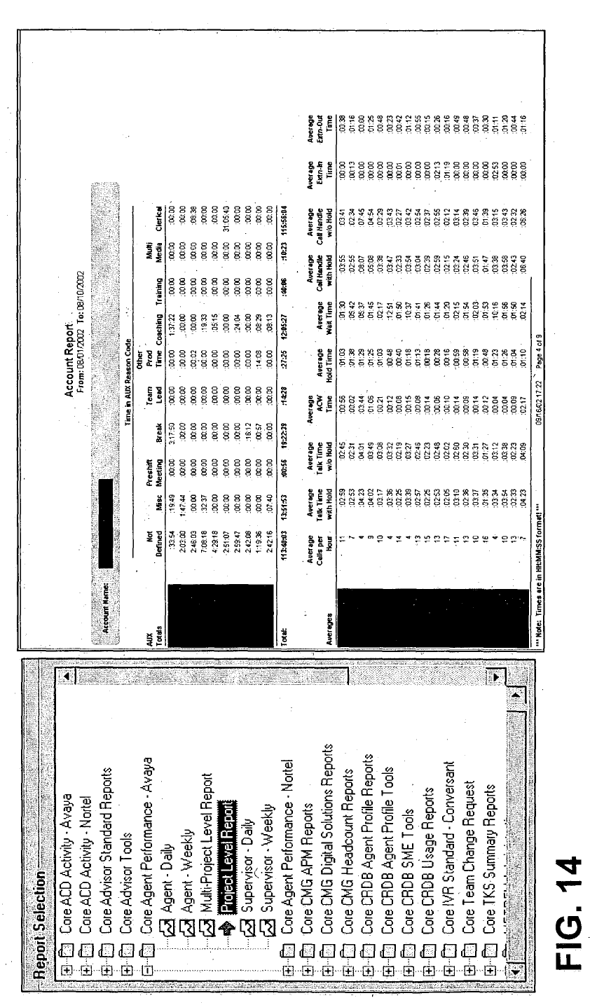

With the cross referencing associated with the events tracked, a number of performance analysis tools are made available, for instance an agent scorecard 126 that allows a team leader or manager to review the performance summaries and status of a number of employees. Agent trending reports 128 provides indications of whether a substandard performance is improving or becoming more and more of a problem. (See FIG. 13.) Different demographic cross sections may be selected, such as an account report 130 so that managers can see how particular clients of an outsourced service are being served by assigned employees, for instance. (See FIG. 14).

These calculations and comparisons are intuitively plotted in block 132 and displayed as an agent dashboard GUI 134 that gives an agent and team leader a frequently accessed and up-to-date snapshot of their current standing relative to the standards and to their peers. Also associated with these performance results are agent performance feedback items 136 that are created by the team leader and acknowledged by the agent to memorialize coaching for improved performance.

In block 138, the team leader may reference these indications from PPM system in order to perform root cause analysis. Determining the root cause of any problem ensures that it does not reoccur in the future. Root Cause Analysis is useful in helping employees achieve the performance goals set by the project. A root cause analysis may be completed whenever an employee's performance is not meeting the guidelines set by the project. One technique in determining the root cause of a problem is to ask why three to five times, thereby eliminating the surface reasons for missing a target and to thus identify the root cause. The following is a list of tools that can help determine the root cause: Brainstorming, Cause and effect analysis (fishbone diagram), Histogram, Graphs, Pareto diagrams, and Checklists. Several steps are useful in conducting root cause analysis: (a) Enlist individuals to help in the root cause analysis. Include individuals that are directly affected by the outcome of the actions to be taken (e.g., Subject Matter Expert, another Team Leader, and/or an Operations Manager). (b) Conduct cause and effect analysis or use any of the helpful tools mentioned in this section. (c) Select the potential causes most likely to have the greatest impact on the problem. Note: It is not enough to identify that the root cause is present when the problem occurs. It must also be present when the problem does not occur. (d) Create and implement an action plan to address the root causes. The action plan may be reviewed to ensure that the corrective actions do not cause more problems.

An example of a root cause analysis checklist may be the following inquiries:

(a) Is there a performance gap (i.e., basis, difference from target)? If so, what is the performance gap? Else, no further analysis required. (b) Is it worth the time and effort to improve (i.e., importance, cost, consequence if ignored, effect if corrected)? If yes, consider further its importance. No, do not waste time and effort. (c) Does the Team Member know that the performance is less than satisfactory (e.g., feedback given to team member, team member aware of unsatisfactory performance)? If yes, consider the basis for how you know the team member is aware that his performance is less than satisfactory. Else, provide appropriate feedback to the team member. (d) Does the Team Member know what is supposed to be done and when (i.e., objectives and standards been defined and mutually agreed upon and clearly stated)? If yes, how do you know the Team Member knows what is suppose to be done and when? Else, set clear goals, objectives and standards with the Team Member to clarify expectations. (e) Are there obstacles beyond the Team Member's control (e.g., conflicting demands, team member lacks necessary authority, time and/or tools, environmental interference such as noise or poor lighting, outdated or unduly restrictive policies in place)? If not, what have you done to verify that there are no obstacles? Else, take appropriate action to remove obstacles. (f) Are there negative consequences or a lack of positive consequences following positive performance, and in particular, how does the team member feel about the rewards for performance? If so, change the consequences, such as reward positive performance and work with the Team Member to provide appropriate support and create a developmental plan. No, eliminate this reason as a possibility for poor performance from the Team Member. (g) Are there positive consequences following non-performance? Specifically, is this team member receiving rewards of avoiding negative consequences even though performance is poor, or do they perceive other team members as doing so? What reward is the Team Member or other team members receiving for non-performance? How will you change the consequences? If yes, for instance, someone else does the work, if the Team Member does not do it, then change the consequences. Communicate expectations to the Team Member. Create a developmental plan. Else, eliminate this as a possibility for poor performance from the Team Member. (h) Does the team member understand the consequences of poor performance? How will the Team Member change the performance? What will you do to provide coaching? If not, work with the Team Member to define consequences and create a developmental plan. If so, stop here. Consider lack of motivation as the problem for poor performance. (i) Is the Team Member willing to undertake appropriate change? If yes, work with the team member to create a developmental plan. If not, terminate or transfer the team member, or live with the performance as it is.

TABLE 1

| Quality | | |
|---|---|---|
| Measurement | Review | Action |
| Call Quality | Agent | Determine if changes to procedures have |
| | Knowledge | been reviewed with Agents. Determine |
| | | if Agents understand each element of the |
| | | call flow and the system. Determine if |
| | | Agents are rushing through the calls. |
| | Expectations | Determine if the types of improvement |
| | | opportunities are clearly defined and |
| | | understood by Agents. |
| | Other | Review the following measures to |
| | Measures | determine their impact on Call Quality |
| | | (e.g., After Call Work, Average Handle |
| | | Time, Attrition) |
| | Quality | Meet with Agents to discuss trends and |
| | Results | identify the root cause. |
| | Staffing | Review the schedule to determine if |
| | | appropriately staffed so that the Agent is |
| | | not tempted to rush through the calls |
| | | (i.e., look at staffing for peak |
| | | calling periods. |
| IT vs. CMS | Call Quality | Monitor calls and follow-up to determine |
| Call | | if the calls were dispositioned correctly. |
| Dispositioning | Environment | Observe the Agents and determine why |
| | | Agents are not dispositioning the calls |
| | | (e.g., talking to neighbors, etc.). Meet |
| | | with Agents and discuss any |
| | | obstacles in dispositioning calls |
| | | correctly (e.g., coding issues). |
| | | Determine if Agents understand the |
| | | dispositioning procedures. |
| | Systems | Determine if the codes in the system |
| | | accurately reflect the call types. |

TABLE 3

| Effectiveness | | |
|---|---|---|
| Measurement | Review | Action |
| Agent Productivity | Online Hours | Verify the Agent was scheduled to work |
| | | enough hours to be able to meet the goal (i.e., |
| | | take into consideration training and vacation |
| | | that may have been scheduled). |
| | | Determine if off-line activities are affecting |
| | | Agent Productivity. |
| | | Review Agents Log In and Log Out reports to |
| | | determine if Agents are staying online for the |
| | | appropriate amount of time. |
| | Other Measures to | Review the following measures to determine |
| | Review | their impact on Agent Productivity: |
| | | After Call Work |
| | | AUX Time |
| | | Schedule Adherence |
| | | TKS Conformance |
| Schedule Adherence | Agents Changes | Determine if the Agent's ESC and IEX |
| | | schedule accurately reflect the Agent's |
| | | scheduled hours. |
| | Environment | Determine if Agents are following the |
| | | attendance and tardy policy. |
| | | Observe Agents in their work area to |
| | | determine if Agents are talking with neighbors |
| | | instead of logging on to the phones when |
| | | appropriate. |
| | | Review Agents Log In and Log Out reports to |
| | | determine if Agents are staying online for the |
| | | appropriate amount of time (i.e., leaving and |
| | | returning from breaks on time). |
| | Staffing | Determine if appropriately staffed to meet the |
| | | volume. |
| | Systems | Determine if everything is entered correctly |
| | | into Digital Solutions. |
| TKS Conformance | | Determine whether Agents are coding time |
| | | appropriately in TKS. |
| | | Meet with the Agent to determine why the |
| | | Agent is not following TKS procedures. |

TABLE 4

| Attendance | | |
|---|---|---|
| Measurement | Review | Action |
| Absenteeism/ | Workplace | Meet with Agents to identify root cause |
| Tardies | Environment | and to discuss Agents' concerns. |
| | Schedule | Review schedule with Agent to determine |
| | | if a change to the schedule would |
| | | eliminate further attendance problems. |

In block 140, corrective action plans are used to identify areas for improvement and a timeline in which expectations are to be reached. These plans may answer who, what, when and where and consider the conditions and approvals necessary for success. Action planning is used when negative trends are identified in an Agent's performance. Creating a plan will establish a roadmap to achieve excellent call quality. It also ensures an organized objective implementation. A typical procedure for creating action plans would include: (1) Analyze the proposed improvement or solution; (2) Break it down into steps; (3) Consider the materials and numbers of people involved at each step; (4) Brainstorm, if necessary, for other items of possible significance; (5) Add to the list until the team thinks it is complete; and (6) Follow-up frequently to ensure the action plan is completed on time and accurately.

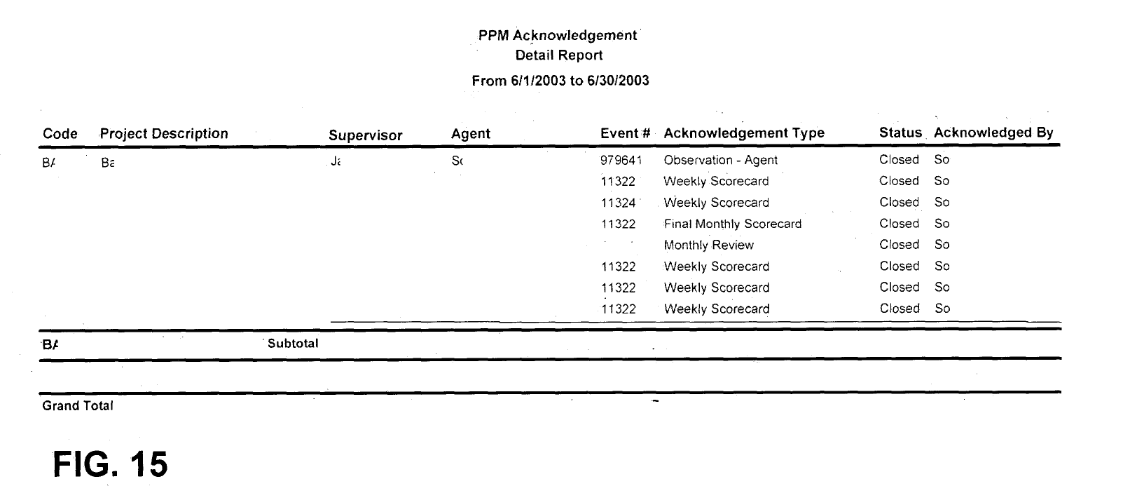

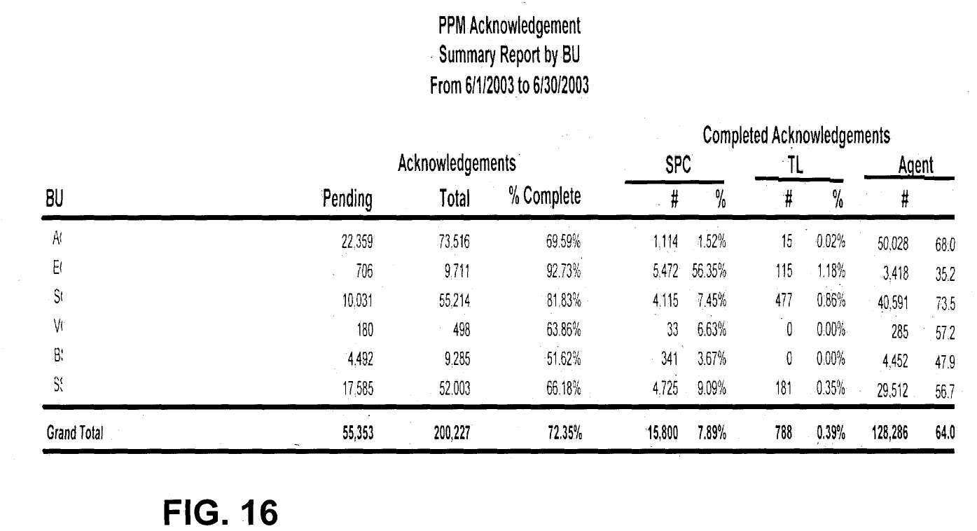

In block 142, the team leader provides feedback on the agent's performance, including any corrective action plans that are to be implemented. Thereafter, the team leader captures the individual feedback items from the feedback session into the PPM system (block 144). Thereafter, the agent is prompted to acknowledge these items set into the PPM system by his team leader, perhaps with comments of explanation or disagreement (block 146). The PPM system tracks the setting and acknowledgement of feedback (block 148), which supports various reports and interactive screen to facilitate the process, such as acknowledgement pending/completed queues/details 150. (See FIGS. 15, 16.)

Periodically, the weekly or monthly or other cycle of evaluation and feedback is used for a review (e.g., quarterly, semi-annually, annually), which may coincide with compensation bonuses or raises. The PPM system tracks these periodic agent or team leader review (block 152), and therefrom produces various reports or interactive screens to facilitate their use, such as tracking summaries 154 and an agent review ranking report 156.

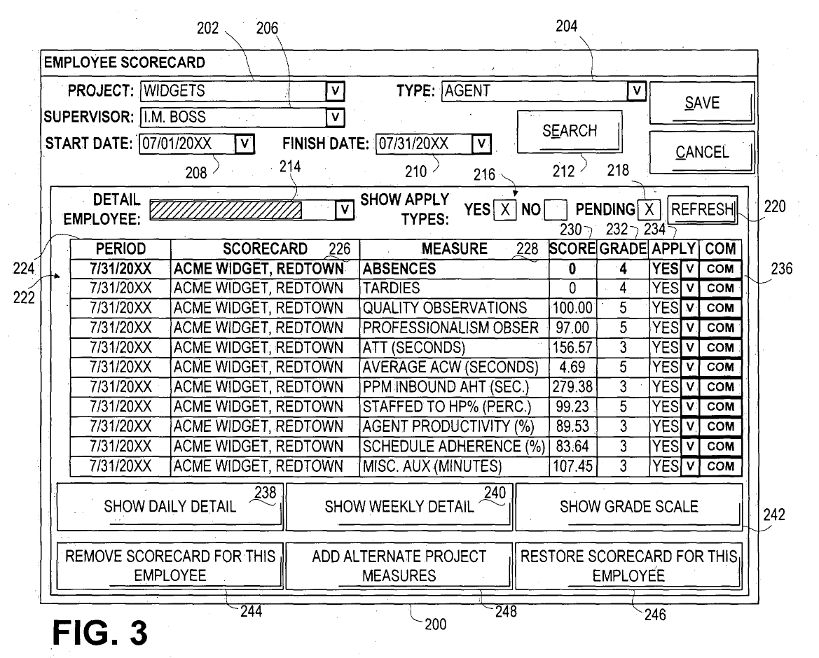

In FIG. 3, an employee scorecard 200 allows a team leader to select one or more factors, such as project 202, type of employee (e.g., team leader, agent) 204, assigned supervisor 206 (e.g., either the team leader interacting with the screen or another supervisor assigned to the team leader/manager), and a period of review, such as start date 208 and finish date 210. Upon selecting search button 212, a listing of employees are provided (not depicted), typically a listing of agents assigned to the team leader whose log-in identifier enables him to view this subset of employees. One particular agent is selected with a detail employee pull-down 214, and filtering as desired for only applied measures yes/no radio buttons 216 and/or unreviewed (“pending”) radio button 218, with the listing displayed upon selecting a refresh button 220. For each performance measure, a record 222 is displayed comprised of a time period 224, scorecard description (e.g., project and facility) 226, scorecard measure 228, score 230, grade 232, apply/not apply toggle 234, and manually-entered comment button 236, the latter launching a text entry window for written comments.

A top detail record 222 is shown highlighted as a currently selected record that may be interacted with by buttons 238-248. In particular, a “show daily detail” button 238 will show daily statistics associated with the selected measure. A “show weekly detail” button 240 will show weekly statistics associated with the selected measure. A “show grade scale” button 242 will pop-up a legend explaining the grading scale standards to assist in interpreting the grades presented. A “remove scorecard for this employee” button 244 is used early in a feedback period to remove a pending scorecard until completed and restored with a “restore scorecard for this employee” button 246 when readily to be applied or not applied. An “add alternate project measures” button 248 is not grayed out when the employee is assigned to more than one project. Selecting button 248 allows the designating of the other projects and populating the scorecard with these alternate project measures.

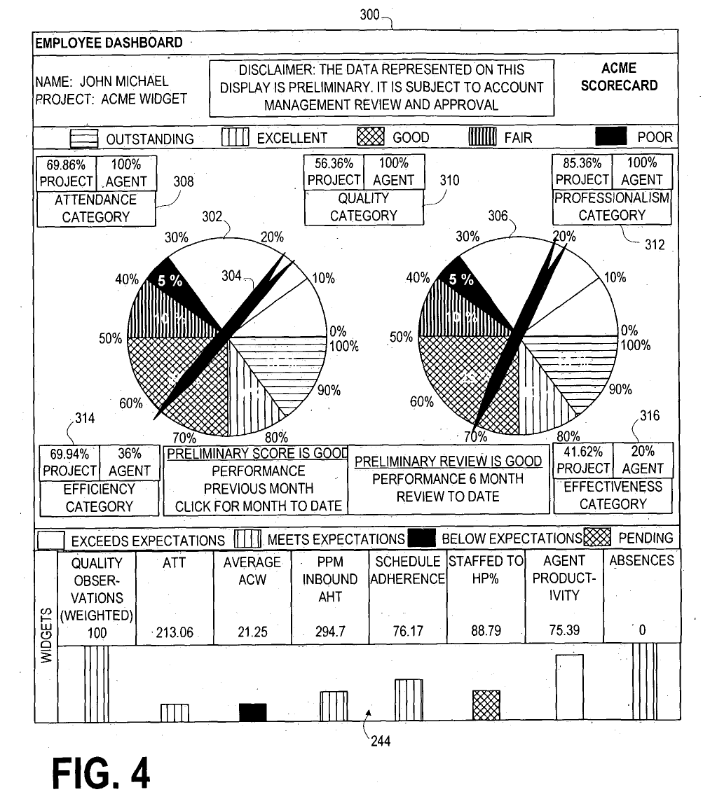

In FIG. 4, an agent dashboard GUI 300 gives an intuitive and comprehensive presentation of the agent's performance as compared to standards and to his peers and can be frequently referenced to instruct on areas needing attention. An individual pie chart 302 summarizes the 5 grade ranges by proportioning their relative weighting and stacking them radially from poor, fair, good, excellent and finally to outstanding. An arrow 304 shows the composite score for the agent, which in this instance falls within the good grade. A similar pie chart 306 is presented that is a summary for all of the team. Category measure summaries of attendance, quality, professionalism, efficiency and effectiveness are summarized by respective percentage values 308-316 for both the agent and the project as well as a grade color-coded bar chart 318.

Performance Reports for Management use.

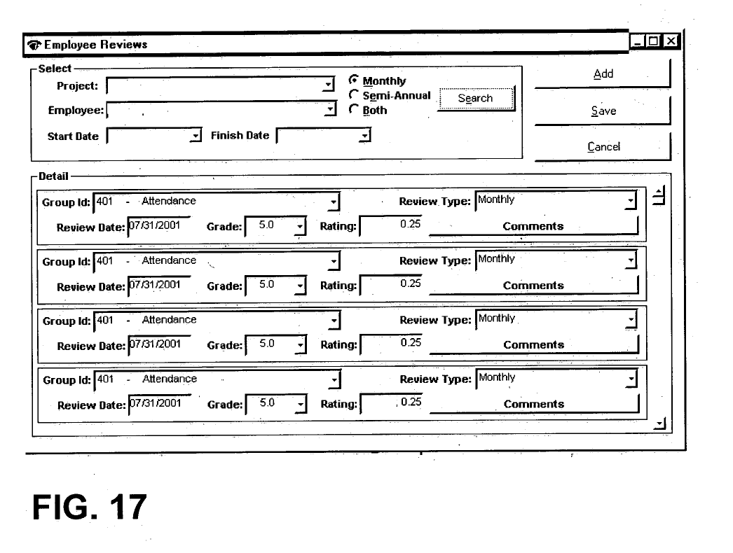

Senior Management Reports and Screens Guide leverages the comprehensive performance data and analysis of agents and team leaders to detect trends and problem areas. First, a Employee Performance Feedback (CRDB) report displays employees' (i.e., managers and Agents) month-to-date scorecard results and documented feedback, thereby assisting in providing coaching and feedback to employees. Second, an Employee Reviews (CRDB) report provides a summary of an employee's monthly scorecard results by category, overall points achieved and documented feedback, which assists in providing coaching and feedback to employees on their overall results. (See FIG. 17.) Third, a Program Performance Month-to-Date provides a roll-up of program-level scorecard data, assisting in managing results across teams and centers. Fourth, an Agent Productivity Management (APM) Cross Reference Detail Report displays the start date of a project and includes the following: switch number, splits, IEX code, IEX team IDs, TKS and PSF project code, thereby determining where the APM Measures report is pulling information. Fifth, an APM Measures Report with Targets and Charts sorts by Business Unit, center, portfolio, billing unit and PSFN project code and compares the following information to targets determined by the Project: agent productivity, phone time variance, percent occupancy, call service efficiency, percent of calls forecasted accurately, percent of average handle time forecasted accurately, on-line conformance and on-line adherence. Tracking a project's efficiency on key measures, and to review the accuracy of client forecasts for business planning (i.e., staffing etc.). Sixth, an APM Trend Report sorts by business unit, center, portfolio, billing unit and PSFN project code. It provides three months of project trends for the following information: agent productivity, phone time variance, percent occupancy, call service efficiency, percent of calls forecasted accurately, percent of average handle time forecasted accurately, on-line conformance and on-line adherence, on-line diagnostic measures, breakdown of TKS categories and percent billable and non billable time. It identifies trends and improvement opportunities. Seventh, a TKS Activity Analysis Report—Detail provides project level data on where payroll time is being spent i.e., total coaching hours, meeting hours, training hours, etc. It assists in conducting project level analysis to ensure the team is following standard processes and to identify improvement areas. Eighth, a TKS Activity Analysis Report—Summary provides a summary of daily, weekly and monthly data for TKS data analysis. It also provides interval data and displays statistics on a project's billable time. Ninth, a TKS Agent Productivity Report—Detail provides by TKS Project code and employee the following information: manned time, other productive, productivity and phone time variance, thereby assisting managers in identifying how a project can be more efficient. Tenth, a TKS Agent Productivity Report—Summary provides by Business Unit, location, and TKS project(s) the following information: manned time, other productive, productivity and phone time variance. It assists managers in identifying how a project can be more efficient. Eleventh, a Yes/No Line Item Trends by Agent, Team Leader, and Project report provides call monitoring line item results of a project's evaluations completed by QA, Team Leader, OJT, client and a summary of all evaluations. It Assists in conducting analysis on project level quality results and identify areas for improvement. Twelfth, various Agent, Skill and VDN Reports provides a summary of monthly, weekly, daily and interval data for ACD and Agent. Thirteenth, Displayed project statistics report assists in managing employees' performance, including displaying billing data for client bills. Fourteenth, various ACD DN, Agent, CDN and DNIS Reports supplies a summary of monthly, weekly, daily and interval data for ACD, Agent, CDN and DNIS data. Displays project statistics. It assists in managing employees' performance and displays billing data for client bills. Fifteenth, various Multi-project, Project, Team Leader and Agent Level Reports identifies detailed and summary data daily, weekly, and monthly for key metrics at the following levels: multi-project, a single project, Team Leader and Agent. Assists in managing the key metrics and analyzing the raw data for the key metrics. Sixteenth, various Multi-project, Project, Team Leader and Agent Level Reports identifies detailed and summary data daily, weekly, and monthly for key metrics at the following levels: multi-project, a single project, Team Leader and Agent. It assists in managing the key metrics and analyzing the raw data for the key metrics. Seventeenth, various Business Unit (BU), Center, Project and Job Category Headcount Reports supplies headcount information from CORT at the following levels: business unit, project and job category. This report should be pulled using the same start and finish date. It assists in verifying the accuracy of the information in CORT and developing business plans. Eighteenth, a Statistical by Interval and by Summary report supplies data on all calls that went through the IVR. Displays IVR usage, conversant routing, etc. Nineteenth, a PTO Report displays paid time off (PTO) information by project, team and employee, assisting in managing employee PTO days accrued and taken. Twentieth, various Attrition Reports (e.g., 12 Month Rolling, Calendar, Turnover Analysis and Employee Term Listings) supplies attrition information from CORT at the following levels: business unit, vertical, center, project and job category to assist in verifying the accuracy of the information in CORT, to develop action plans and strategic business plans. Twenty first, various Program, Finance, and Activity Summary Reports provides TKS reporting through CRDB for tracking and managing Agent activities, payroll, etc.

PPM Process Conformance is key objective of several reports that can be used to verify whether managers and projects are complying with the process. First, a Project Scorecard Status report identifies the measures that have populated on the scorecard. Retrieves both applied and pending measures. Identifies automated measures that have not populated on an individual's scorecard or need to be added manually. Second, a Scorecard Measures Exception Report identifies the following types of measures by employee name: Not Applied, Removed and Pending. It assists in identifying frequency of unapplied and pending measures and the manager responsible. Third, a Scorecards with Zero Grade displays employees who have received a zero due to their scores falling outside the grading criteria. It assists in identifying issues that need to be investigated and resolved prior to final scorecard processing. Fourth, a Feedback Status Report identifies, by Team Leader and Agent, the percent of feedback that has been acknowledged in the system. Coaching Team Leaders on providing timely feedback to Agents. Fifth, an Acknowledgement Detail Report identifies acknowledgement type, Event number, status and by whom it was acknowledged by project, supervisor, and Agent. It assists in evaluating the status of acknowledgement types and by whom they were acknowledged. Sixth, an Acknowledgement Summary Report displays by business unit, center, project, supervisor, and Agent the following: Total number of acknowledgements, Number of pending acknowledgments, Percentage of completed acknowledgements, and Number and percentage of acknowledgements completed by a Scorecard Project Coordinator, Team Leader, and Agent. It assists in evaluating the completion percentage of acknowledgements and by whom they were acknowledged. Seventh, a Report Usage by Project & User Type & User identifies which employees are pulling reports and the reports being reviewed. It assists in providing coaching and feedback to managers and other employees (i.e., Reports Specialists, etc.). Eighth, a Report Usage by Folder BU, Report, Project Level identifies by business unit and project level what folders have been reviewed, thereby assessing the level of CRDB and PPM process usage by a project.

Administrative—Core CRDB Agent Profile Reports identify the structure necessary for scorecards to accurately roll-up at each level. First, a Supervisor Hierarchy Report identifies the structure of a specific project, from the Agent level and to the President level, providing a quick and easy way to find an employee's manager and determine if the appropriate employees are on the list. Second, a Supervisor Hierarchy Audit Detail report shows by project the following employee information: name, Employee Number, active or inactive status, level of authority in CRDB, and Supervisor's Employee Number. Provides a quick view of employee linkages that projects can verify the accuracy of the Hierarchy report. Third, a CRDB CMS Dictionary provides split, VDN, and skill information at the project level and is utilized as a quick reference tool for managers when discussing changes with Workforce Management, etc. Fourth, a Project and PPM Rollup List by SME shows CRDB SME's by project, program, sponsor and Workforce Management group. Displays CRDB SME to contact when a project needs assistance, displaying agents, Team Leaders & Operations Managers Only.

Some reports are used strictly by Operations Managers and Team Leaders to manager their employees. First, an Average Quality by Guideline and Evaluator Report identifies when the first and last call monitoring evaluation was completed, average overall quality score and the total number of evaluations, thereby assisting in providing coaching and feedback to direct reports on monitoring goals and overall results. Second, a Quality Summary by Agent/Team Leader Report displays by project the Team Leaders, their Agents, number of evaluations completed per Agent, average overall quality score from QA, Team Leader (TL), QA & TL, OJT, client and all evaluations, thereby assisting in managing and providing feedback on project level, Team Leader level and Agent level results. Third, an Employee Review Rankings report ranks employees against their peers according to the points received on the scorecards on a monthly basis over the six-month period, determining Agent's appraisal ratings within a project. Fourth, a Semi-Annual Performance Appraisal report shows employees' performance over the six-month period, assisting in providing coaching and feedback to employees. Fifth, an Agent Profile by Project report provides Agent's name, Employee number, system ids, active status, and Team Leader's name, assisting Managers in troubleshooting why a measure is not displaying on a scorecard. Sixth, a Team Change Request Maintenance report provides a list of Agents and their Team Leaders by project. Transfers Agents to other Team Leaders within the same project, as well as transferring Agents to other projects. Seventh, a Manager Approval report provides Operations Managers with a list of pending Agent transfers; Approving or denying Agent transfer requests. Eighth, a Delegation of Authority report enables Operations Managers to delegate the authority to approve Agent transfer requests, delegating transfer approval authority when an Operations Manager is not in the office. Ninth, a Team Change Request Status Report provides a list of Team Change requests and their status, and tracks Team Change requests.

In use, a program performance management (PPM) system 10 is set up as part of a customer management system (CMS) network 14, leveraging already existing quantitative information regarding employee work activities (e.g., attendance, time engaged in performing specific tasks, scheduling, sales results, etc.). In addition to automatic measures such as efficiency, effectiveness, and attendance, a team leader interacts with an employee scorecard 54 to input manual measures of quality and professionalism. These measures are compiled into a score that may be compared to targets and to the peers of the employee, with the results intuitively presented to the employee on an agent dashboard 134. Feedback acknowledgement is facilitated by the PPM system 10, as well as tracking accomplishment of periodic reviews, with an array of reports available for upper management to evaluate agent, team leader, and project performance.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

For example, although performance evaluation of agents who perform customer management services (CMS) is illustrated herein, it should be appreciated that aspects of the invention have application to other industries and services.

What is claimed is:

1. A method of managing performance of an employee, comprising:
collecting a set of quantitative data generated as a result of employee activities;
collecting a set of qualitative data input characterizing employee performance;
generating a performance grade based on the sets of quantitative and qualitative data; and
displaying an intuitive representation of the performance grade.

2. The method of claim 1, wherein collecting the set of quantitative data comprises collecting customer management service (CMS) information characterizing actions by a customer service agent from a plurality of CMS systems.

3. The method of claim 2, wherein collecting the set of quantitative data further comprises:
receiving time keeping information;
receiving an assigned schedule;
referencing an attendance target; and
generating an attendance score based on a comparison of the time keeping information with the assigned schedule and the attendance target.

4. The method of claim 2, wherein collecting the set of quantitative data further comprises:
receiving call duration information receiving time keeping information;
referencing an efficiency target; and
generating an efficiency score based on a comparison of the call duration information with the time keeping information and efficiency target.

5. The method of claim 1, wherein collecting the set of qualitative data input further comprises:
prompting a supervisor to input qualitative performance scores;
accessing qualitative comment entries in response to a supervisor input;
receiving a qualitative entry from the supervisor referencing a qualitative target; and
generating a qualitative score based on a comparison of the qualitative entry with the qualitative target.

6. The method of claim 1, wherein collecting the set of quantitative data further comprises:
receiving time keeping information;
receiving on-line time information;
referencing an effectiveness target; and
generating an effectiveness score based on a comparison of the on-line time information with the time keeping information and effectiveness target.

7. The method of claim 1, further comprising excluding a measure in response to a supervisor do-not-apply selection.

8. The method of claim 1, further comprising:
plotting a grading scale of a based upon a compiled plurality of weighted quantitative and qualitative performance measures; and displaying an indicator upon the grading scale corresponding to a compiled performance score.

9. The method of claim 8, further comprising:
referencing compiled performance scores for a plurality of individuals assigned to a group;
computing a combined score for the group; and
plotting a grading scale of a based upon a compiled plurality of weighted quantitative and qualitative performance measures; and displaying an indicator upon the grading scale corresponding to the computed combined score for the group.

10. The method of claim 1, further comprising assigning the quantitative data to a supervisor of the employee for managing performance of the supervisor.

11. A method of managing performance of an employee, comprising:
displaying performance scores of an employee to a supervisor;
receiving a feedback acknowledgement entry from the supervisor;
prompting the employee to interact with the feedback acknowledgement entry; and
tracking accomplishment of the interaction.

12. The method of claim 1, further comprising:
prompting a supervisor to make a periodic review;
ranking employees in response to the periodic review;
tracking accomplishment of the review; and
reporting the employee rankings for performance incentive decisions.

13. The method of claim 11, further comprising generating performance scores representative of customer management service measures.

14. The method of claim 13, further comprising:
generating a performance score based on attendance;
generating a performance score based on efficiency;
generating a performance score based on effectiveness;
generating a performance score based on quality; and
generating a performance score based on professionalism.
